(19) United States
(12) Patent Application Publication
(10) Pub. No.: US 2014/0212861 A1
(43) Pub. Date: Jul. 31, 2014

(54) EDUCATIONAL SUTURING APPARATUS

(71) Applicant: Peter Joseph Romano, Parma, MI (US)

(72) Inventor: Peter Joseph Romano, Parma, MI (US)

(21) Appl. No.: 14/034,724

(22) Filed: Sep. 24, 2013

Related U.S. Application Data
(60) Provisional application No. 61/758,016, filed on Jan. 29, 2013.

(51) Int. Cl. G09B 23/30

(52) U.S. Cl. CPC G09B 23/30
USPC 434/267

(57) ABSTRACT

An educational suturing apparatus is presented. The educational suturing apparatus may include a support layer and an imitation skin layer. The support layer may include an insert protruding from the support layer. An inner surface of the imitation skin layer may fit over the insert. The imitation skin layer may be made of an elastomer so that an incision may be cut and sutured back together.

### CROSS-REFERENCE TO RELATED APPLICATION

This application claims the benefit of priority of U.S. provisional application number 61/758,016, filed Jan. 29, 2013, the contents of which are herein incorporated by reference.

### BACKGROUND OF THE INVENTION

The present invention relates to an education suturing apparatus and, more particularly, to an education suturing apparatus that resembles an animal part, such as a human face.

Surgical suture is a medical device used to hold body tissues together after an injury or surgery. Application generally involves using a needle with an attached length of thread. A number of different shapes, sizes, and thread materials have been developed over its millennia of history.

Currently, students learning how to suture have no reliable way of being taught to perform and practice cosmetic suturing techniques. This is because traditional suturing lessons use pig's feet, which is impersonal and unrealistic, since pig's feet have no contours or grooves similar to the human face. Further, pig's feet are not sanitary and are not reusable. Pig's feet are also not available to the general public, restricting others from practicing to suture.

As can be seen, there is a need for a more realistic suturing apparatus that may be re-used and is sanitary.

### SUMMARY OF THE INVENTION

In one aspect of the present invention, an educational suturing apparatus comprises: a support layer comprising an insert protruding from the support layer; and an imitation skin layer comprising a front surface and a rear surface, wherein the front surface resembles an animal part, and the rear surface is formed to fit over the insert of the support layer.

In another aspect of the present invention, a method of simulating the suturing of an animal comprises: providing a support layer comprising an insert protruding from the support layer; providing an imitation skin layer comprising a front surface and a rear surface, wherein the front surface resembles an animal part; placing the imitation skin layer on the support layer, wherein the rear surface is adjacent to the insert; making an incision on the imitation skin layer; and suturing the incision back together.

These and other features, aspects and advantages of the present invention will become better understood with reference to the following drawings, description and claims.

### BRIEF DESCRIPTION OF THE DRAWINGS

FIG. 1 is a perspective view of the present invention showing a sanitary layer covering an imitation skin layer;

FIG. 2 is a perspective view of the present invention showing without the sanitary layer;

FIG. 3 is a section detail view of the present invention along line 3-3 in FIG. 1; and

FIG. 4 is an exploded view of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an educational suturing apparatus. The educational suturing apparatus may include a support layer and an imitation skin layer. The support layer may include an insert protruding from the support layer. An inner surface of the imitation skin layer may fit over the insert. The imitation skin layer may be made of an elastomer so that an incision may be cut and sutured back together.

The present invention may include a suturing technique educational lacerated lab apparatus. The present invention may assist students to learn the proper suturing techniques, which is accomplished since the present invention provides a realistic, sanitary and reusable device that may be available in and outside of the classroom. The present invention may offer an easy to use design and teaching tool for all skill levels, from novice to professional.

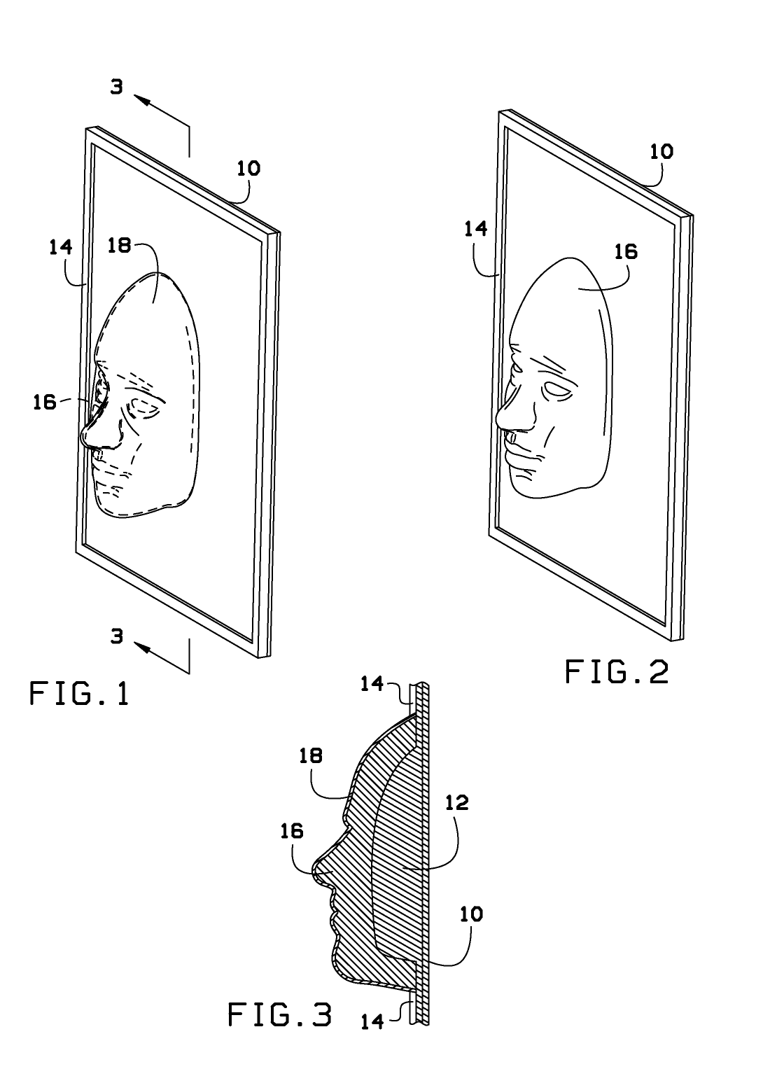

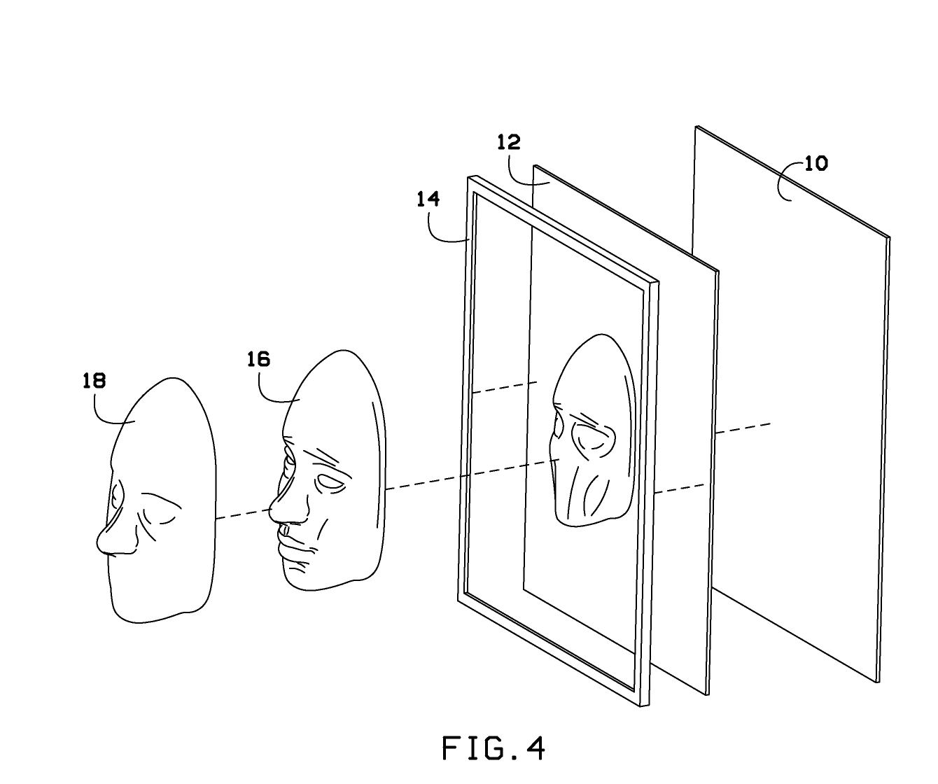

Referring to FIGS. 1 through 4, the present invention may include an educational suturing apparatus. The educational suturing apparatus may include a support layer 12 and an imitation skin layer 16. The support layer 12 may include an insert 20 protruding from the support layer 12. The imitation skin layer 16 may include a front surface and a rear surface. The front surface may resemble an animal part. The rear surface may be formed to fit over the insert 20 of the support layer 12. A user may make an incision through the front surface and suture the incision back together.

In certain embodiments, the present invention may include additional components. As illustrated in the Figures, the present invention may include a frame 14 and a base 10. The support layer 16 may be within the frame 14, in between the frame 14 and the base 10. The frame 14 may provide a border around the imitation skin layer 16, which allows for easy transportation and interchangeability of the support layer 16. In addition, the present invention may further include a sanitary layer 18, in order to cover and protect the imitation skin layer 16 from becoming dirty before use.

In certain embodiments, the imitation skin layer 16 may be made of a polymer. The polymer may be an elastomer, so that a user may easily make an incision through the polymer and begin suturing. The elastomer of the present invention may be silicone, since silicone may resemble animal skin. As illustrated in the Figures, in certain embodiments of the present invention the front surface of the imitation skin layer 16 may resemble a human face, such as a women's face.

A method of simulating the suturing of an animal may include the following. A support layer that may include an insert protruding from the support layer is provided. An imitation skin layer that may include a front surface and a rear surface is also provided. The front surface may resemble an animal part. The imitation skin layer may be placed on the support layer so that the rear surface of the imitation skin layer is adjacent to the insert of the support layer. An incision may be made on the imitation skin layer and a user may suture the incision back together. The imitation skin layer may be an elastomer and the front surface may resemble a human face.

A method of making the present invention may include the following. The frame, base, and support layer may be vacuum formed plastic. Medical grade silicone may be poured into a mold to make the imitation skin layer. To assemble the present invention, the base, the support layer, and the frame 14 may interlock together. The imitation skin layer may form fit over the insert of the support layer, and the sanitary layer may form fit over the imitation skin layer. The present invention may further be upgraded to include add-ons that resemble nerves, muscle, foreign objects, tumors, lesions, cancer, warts, moles, growths, and advanced cosmetic suturing.

The present invention may be used as a medical training tool to teach proper suturing skills to medical students, Physician Assistant students, and Nurse Practitioner students. The present invention may be made of artificial materials, such as polymers. The manufactured imitation skin layer may be realistic, replaceable, reusable, safe, sanitary, and without odor. The present invention may be taken home and used to practice. The present invention may effectively teach students to suture on a lifelike model, with the end result being a fully trained and prepared student entering into their profession.

It should be understood, of course, that the foregoing relates to exemplary embodiments of the invention and that modifications may be made without departing from the spirit and scope of the invention as set forth in the following claims.

What is claimed is:

1. An educational suturing apparatus comprising:
a support layer comprising an insert protruding from the support layer; and
an imitation skin layer comprising a front surface and a rear surface, wherein the front surface resembles an animal part, and the rear surface is formed to fit over the insert of the support layer.

2. The educational suturing apparatus of claim 1, further comprising a frame and a base, wherein the support layer is sandwiched in between the frame and the base.

3. The educational suturing apparatus of claim 1, further comprising a sanitary cover formed to fit over the front surface of the imitation skin layer.

4. The educational suturing apparatus of claim 1, wherein the imitation skin layer comprises a polymer material.

5. The educational suturing apparatus of claim 4, wherein the polymer is an elastomer.

6. The educational suturing apparatus of claim 5, wherein the elastomer is silicone.

7. The educational suturing apparatus of claim 1, wherein the front surface resembles a human face.

8. A method of simulating the suturing of an animal comprising:
providing a support layer comprising an insert protruding from the support layer;
providing an imitation skin layer comprising a front surface and a rear surface, wherein the front surface resembles an animal part;
placing the imitation skin layer on the support layer, wherein the rear surface is adjacent to the insert;
making an incision on the imitation skin layer; and
suturing the incision back together.

9. The method of claim 8, wherein the imitation skin layer comprises an elastomer.

10. The method of claim 8, wherein the front surface resembles a human face.
